(19) United States
(12) Patent Application Publication
(10) Pub. No.: US 2013/0113737 A1
(43) Pub. Date: May 9, 2013

(54) INFORMATION PROCESSING DEVICE, INFORMATION PROCESSING METHOD, AND COMPUTER PROGRAM

(71) Applicant: SONY CORPORATION, Tokyo (JP)

(72) Inventor: Yutaka SHIBA, Tokyo (JP)

(73) Assignee: SONY CORPORATION, Tokyo (JP)

(21) Appl. No.: 13/666,451

(22) Filed: Nov. 1, 2012

(30) Foreign Application Priority Data
Nov. 8, 2011 (JP) 2011244344

(51) Int. Cl. G06F 3/041

(52) U.S. Cl. CPC G06F 3/041
USPC 345/173

(57) ABSTRACT

There is provided an information processing device, including: a position determination unit configured to, on the basis of a touch position of an input object on a display unit that displays first information, determine a touch on a display object that displays second information associated with the first information; an operation input determination unit configured to determine if a predetermined operation is input to the display object; and a display processing unit configured to, on the basis of determination results obtained by the position determination unit and the operation input determination unit, move a display position of the first information so that the second information is displayed at a position in which the moved first information has been displayed.

### BACKGROUND

The present disclosure relates to an information processing device, an information processing method, and a computer program. More specifically, the present disclosure relates to an information processing device, an information processing method, and a computer program that perform a process of calling associated information associated with information displayed on a display unit.

Mobile terminals such as smartphones or tablet terminals have no physical buttons or have a small number of physical buttons provided thereon, and are based on operations input to touch panels. Such terminals allow operations to be input through a gesture such as tap, flick, pinch-in, or pinch-out that has not been able to be implemented with conventional information terminals that are based on operations input to keys (e.g., see JP 2010-108061A).

Meanwhile, as the number of physical buttons is small, and as the number of operations that can be input to the touch panel as well as the display area of the mobile terminal are limited, it would be necessary to devise information that is displayed on the display area and allocation of a function executed through input of an operation. For example, if a menu calling function for calling a menu in accordance with context from an item displayed on the display area is allocated to a long-pressing operation, a menu is displayed when the target item is pressed for a long time.

### SUMMARY

However, as a method of calling a menu through a long-pressing operation is not intuitive, it is often the case that a user does not notice the operation. Although it is possible to display a menu around the target item in accordance with context in advance, the design would become complex, and it would be difficult to secure a space for displaying a menu in advance on a mobile terminal with a narrow display area.

Thus, it is desirable to provide a method that allows a user to execute a function intuitively through natural input of an operation.

According to an embodiment of the present disclosure, there is provided an information processing device, including: a position determination unit configured to, on the basis of a touch position of an input object on a display unit that displays first information, determine a touch on a display object that displays second information associated with the first information; an operation input determination unit configured to determine if a predetermined operation is input to the display object; and a display processing unit configured to, on the basis of determination results obtained by the position determination unit and the operation input determination unit, move a display position of the first information so that the second information is displayed at a position in which the moved first information has been displayed.

According to the embodiment of the present disclosure, when a predetermined operation is input to the display object displayed on the first information, the first information is moved so that the second information associated with the first information is displayed. At this time, by moving the first information in accordance with an operation input to the display object, a user is able to display the second information through an operation that is intuitively easy to understand.

According to another embodiment of the present disclosure, there is provided an information processing method, including: determining, on the basis of a touch position of an input object on a display unit that displays first information, a touch on a display object that displays second information associated with the first information; determining if a predetermined operation is input to the display object; and moving, on the basis of determination results obtained by the position determination unit and the operation input determination unit, a display position of the first information so that the second information is displayed at a position in which the moved first information has been displayed.

According to still another embodiment of the present disclosure, there is provided a computer program causing a computer to function as an information processing device, the information processing device including: a position determination unit configured to, on the basis of a touch position of an input object on a display unit that displays first information, determine a touch on a display object that displays second information associated with the first information; an operation input determination unit configured to determine if a predetermined operation is input to the display object; and a display processing unit configured to, on the basis of determination results obtained by the position determination unit and the operation input determination unit, move a display position of the first information so that the second information is displayed at a position in which the moved first information has been displayed.

As described above, according to the embodiments of the present disclosure, an information processing device, an information processing method, and a computer program are provided that allow a user to execute a function intuitively through natural input of an operation.

### BRIEF DESCRIPTION OF THE DRAWINGS

FIG. 1 is a functional block diagram showing the functional configuration of a mobile terminal having an information processing device in accordance with a first embodiment of the present disclosure;

FIG. 2 is a flowchart showing a process of calling associated information with an information processing unit in accordance with the embodiment;

FIG. 3 is an explanatory diagram illustrating a process of calling associated information with an information processing unit in accordance with the embodiment;

FIG. 4 is an explanatory diagram showing an example in which an additional display object is displayed in an associated information display area;

FIG. 5 is an explanatory diagram showing an example of a method of expanding an associated information display area;

FIG. 6 is an explanatory diagram showing an example in which an object is gradually moved;

FIG. 7 is an explanatory diagram showing an example in which lower-level information of an object is gradually displayed;

FIG. 8 is an explanatory diagram showing an example of display of associated information in accordance with a movement direction of an object;

FIG. 9 is an explanatory diagram showing another example of display of associated information in accordance with a movement direction of an object;

FIG. 10 is a flowchart showing a process of calling associated information with an information processing unit in accordance with a second embodiment of the present disclosure; and

FIG. 11 is a hardware configuration diagram showing an exemplary hardware configuration of a mobile terminal.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that the description will be made in the following order.

1. First Embodiment (Determination based on Pressing Time)
1-1. Functional Configuration of Mobile Terminal
1-2. Process of Calling Associated Information
(1) Summary of Process of Calling Associated Information with Music Application;
(2) Process Flow
(3) Variations
3-a. Display of Associated Information Display Area
3-b. Gradual Movement of Object
3-c. Display of Associated Information in accordance with Movement Direction of Object

2. Second Embodiment (Determination based on pressure)
2-1. Functional Configuration of Mobile Terminal
2-2. Process of Calling Associated information

3. Exemplary Hardware Configuration

### 1. First Embodiment

An information processing device in accordance with the first embodiment of the present disclosure is a device, which performs a process of calling a function, of a terminal that receives an operation input using a touch panel such as a mobile phone like a smartphone or a tablet terminal. Specifically, the information processing device performs a process of calling associated information that is associated with information displayed on a display unit. In this case, the process is performed by the information processing device so that the function can be executed intuitively by a user through natural input of an operation. Hereinafter, the configuration of the information processing device and a function calling process performed by the information processing device will be described in detail.

### [1-1. Functional Configuration of Mobile Terminal]

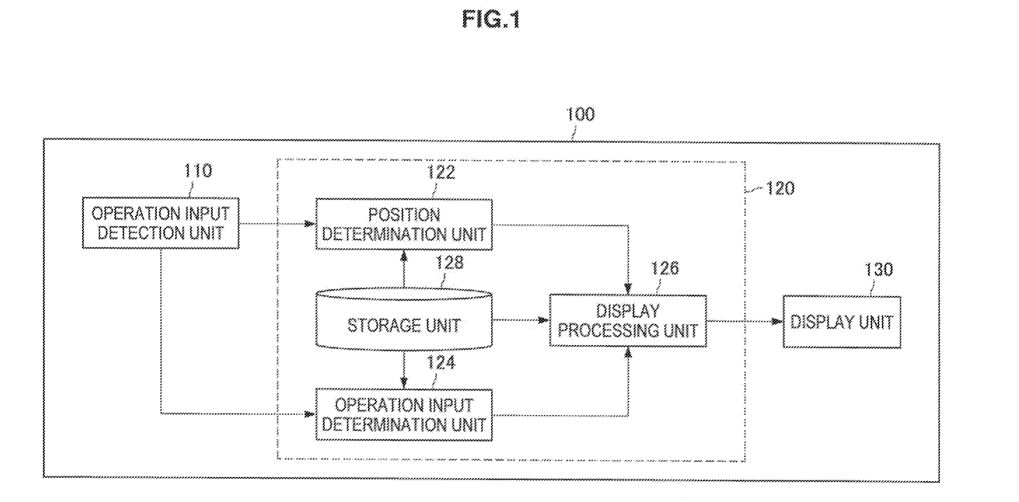

First, the functional configuration of an information processing unit 120 that is the information processing device in accordance with the first embodiment of the present disclosure will be described with reference to FIG. 1. FIG. 1 is a functional block diagram showing the functional configuration of a mobile terminal 100 having the information processing unit 120 in accordance with this embodiment. Although this embodiment exemplarily describes a mobile terminal 100 such as a smart phone as a terminal having the information processing unit 120, the information processing unit 120 can also be applied to other devices.

The mobile terminal 100 in accordance with this embodiment includes an operation input detection unit 110, the information processing unit 120, and a display unit 130 as shown in FIG. 1.

The operation input detection unit 110 is an example of an input device that allows a user to input an operation to operate information, and detects a touch at the position of an input object such as a finger. For the operation input detection unit 110, for example, a capacitive touch panel that detects a touch of an input object by sensing an electric signal through static electricity, a pressure-sensitive touch panel that detects a touch of a finger by sensing a change in pressure, or the like can be used. The operation input detection unit 110 is provided in a manner stacked on the display unit 130 that displays information. Thus, the user is able to operate information displayed on the display unit 130 by moving a finger or the like on the display area. The operation input detection unit 110, upon detecting a touch of an input object, outputs the detection ID provided to identify the touch of the input object, positional information, and touch time as a detection signal to the information processing unit 120.

The information processing unit 120 performs a process of calling associated information that is associated with the information displayed on the display unit. The information processing unit 120 includes, as shown in FIG. 1, a position determination unit 122, an operation input determination unit 124, a display processing unit 126, and a storage unit 128.

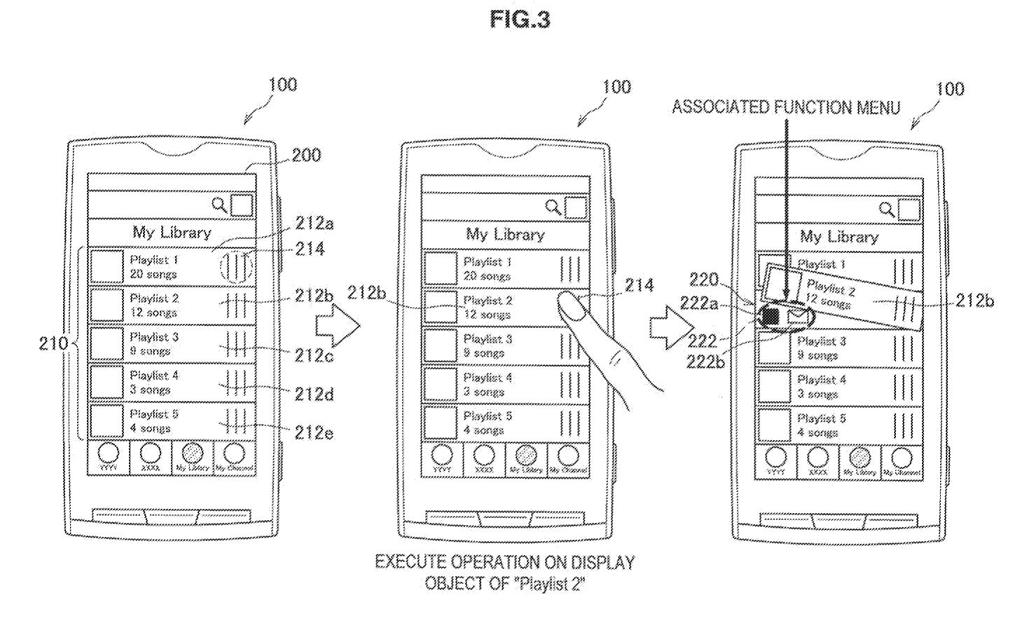

The position determination unit 122 identifies the operation target on the basis of the touch position of the input object detected by the operation input detection unit 110. The information processing unit 120 in accordance with this embodiment performs a process of calling associated information that is associated with the information displayed on the display unit 130. At this time, the position determination unit 122 determines if a display object (indicated by reference numeral 214 in FIG. 3) that displays the associated information is selected as the operation target. The determination result obtained by the position determination unit 122 is output to the display processing unit 126.

The operation input determination unit 124, on the basis of a movement of the input object detected by the operation input detection unit 110, determines if a predetermined operation is input to the display object. The operation input determination unit 124 determines the type of the input operation by continuously monitoring a detection signal of the detection ID provided when the input object has touched the display object. A predetermined operation input for starting a process of calling associated information can be, for example, a long-pressing operation or a short-pressing operation on the display object. The determination result obtained by the operation input determination unit 124 is output to the display processing unit 126.

The display processing unit 126 determines whether to start a process of calling associated information on the basis of the determination results obtained by the position determination unit 122 and the operation input determination unit 124, and processes display information displayed on the display unit 130 in accordance with the determination. The display processing unit 126 starts a process of calling associated information when it is determined that the display object is selected as the operation target and a predetermined operation is input to the display object. The process of calling the associated information is described in detail below. The display processing unit 126, when changing the display information, performs a process of changing the display information, and outputs the updated display information to the display unit 130.

The storage unit 128 stores various information used for the process of calling associated information with the information processing unit 120. The storage unit 128 stores, for example, the type of a predetermined operation input for starting a process of calling associated information, threshold information used for determination (e.g., first determination time and second determination time or end determination time described below). In addition, the storage unit 128 may include memory (not shown) for temporarily storing information when a process of calling associated information is performed. The memory stores, for example, a detection signal (the touch time for the detection ID and positional information at that time) detected by the operation input detection unit 110.

The display unit 130 is a display device that displays information, and a liquid crystal display, an organic EL display, or the like can be used therefor, for example. The display unit 130 displays the display information upon receiving an instruction from the display processing unit 126.

### [1-2. Process of Calling Associated Information]

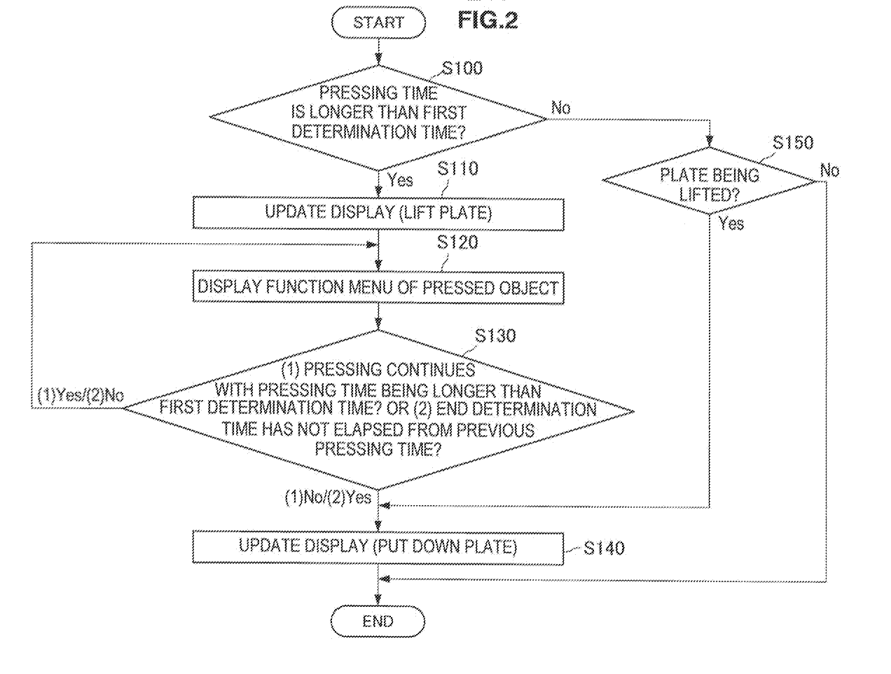

Next, a process of calling associated information with the information processing unit 120 in accordance with this embodiment will be described with reference to FIGS. 2 and 3. FIG. 2 is a flowchart showing a process of calling associated information with the information processing unit 120 in accordance with this embodiment. FIG. 3 is an explanatory diagram illustrating a process of calling associated information with the information processing unit 120 in accordance with this embodiment.

(1) Summary of Process of Calling Associated Information with Music Application

In this embodiment, an operation of a music application on the mobile terminal 100 will be exemplarily described. As shown in the left view of FIG. 3, a list of music playlists (a list of playlists) 210 is displayed in a display area 200 of the display unit 130 of the mobile terminal 100. The music playlists are examples of first information.

The list of playlists 210 may be represented as if it is floated on water, for example. In such a case, an object 212 (212a to 212e) representing each playlist 212 resembles a single plate. When the list of playlists 210 is represented such that it includes a plurality of objects 212 floated on water, the objects 212 are displayed such that they slightly sway, whereby it becomes possible to indicate that each object 212 is movable. As another method of indicating that each object 212 is movable, it is also possible to make each object 212 sway slightly only when a finger touches the playlist 210.

Each playlist includes music pieces constituting the playlist. The object 212 of each playlist displays, for example, the name of the playlist, the number of music pieces included in the playlist, and an icon representing the playlist. For example, a playlist “Playlist 1” associated with the object 212a includes 20 music pieces, and a playlist “Playlist 2” associated with the object 212b includes 12 music pieces.

In addition, at one end (a right end in the example shown in FIG. 3) of the object 212 of the playlist in accordance with this embodiment, a display object 214 for displaying associated information that is associated with the playlist is displayed. The display object 214 is an icon indicating that the object 212 is movable. When a predetermined operation is input to the display object 214, the object 212 can be moved. Although the display object 214 shown in FIG. 3 is an icon including three vertical lines arranged therein, the present technology is not limited thereto. For example, for the display object 214, any given icon such as a knob or a display for inducing a press-in operation can be used.

When a predetermined operation is input to the display object 214, the object 212 of the playlist moves. In this embodiment, movement of the object 212 is represented such that the object 212 moves on the basis of the principle of leverage when an operation of pressing in the display object 214 is input. Specifically, movement of the object 212 is represented such that, with the display object 214 serving as the point of effort, the opposite end of the display object 214 moves toward a user who is opposite the display area 200 of the display unit 130. As described above, when an operation input by the user is made to have relevance to the movement of the object 212, it becomes possible for the user to move the object 212 naturally.

When the object 212 of the playlist is moved, associated information that is associated with the playlist is displayed at a position where the moved object 212 has been displayed. In this embodiment, as shown in the right view of FIG. 3, a function menu 222 associated with the playlist is displayed. The function menu 222 is an example of the second information. Herein, a display area in which the function menu 222 is displayed is referred to as associated information display area 220. The function menu 222 includes, for example, an additional icon 222a for adding music pieces to the playlist, and a mail icon 222b for executing a mail function. Such functions are frequently executed on the playlist. When the object 212 of the playlist is moved so that the associated information display area 220 appears, the function menu 222 becomes operable. Thus, the user is able to easily execute a function associated with the playlist.

### (2) Process Flow

Hereinafter, a process of calling an associated function will be described in detail with reference to FIG. 2. The operation input detection unit 110 of the mobile terminal 110 in accordance with this embodiment continuously monitors a touch of an input object on the display unit 130. Then, upon detecting a touch of the input object on the display unit 130, the operation input detection unit 110 outputs a detection signal to the information processing unit 120.

The information processing unit 120, upon receiving the detection signal, determines if the touch position of the input object is the display object 214 displayed on the object 212 of the playlist with the position determination unit 122. When the input object does not touch the display object 214, a process of calling an associated function is not executed. Meanwhile, when the input object touches the display object 214, the operation input determination unit 124 determines if a predetermined operation for starting execution of a process of calling an associated function has been input to the display object 214 (S100).

In this embodiment, long-press of the display object 214 is used as a requirement to determine that a predetermined operation is input. Specifically, the operation input determination unit 124 determines if the pressing time in which the display object 214 is pressed is longer than the first determination time and, if the pressing time is determined to be longer than the first determination time, starts a process of calling associated information. First, with the display processing unit 126, the object 212 on which the selected display object 214 is displayed is moved, so that the associated information display area 220 is displayed (S110). For example, in the example shown in FIG. 3, a display object 214b of the “Playlist 2” is selected with a finger as shown in the middle view of FIG. 3. When the display object 214b is pressed for a long time, the object 212b of the “Playlist 2” is moved so that it is lifted toward the user as shown in the right view of FIG. 3.

Then, the display processing unit 126 displays the function menu 222 in the associated information display area 220 displayed at a position where the moved object 212 has been located (S120). In the example shown in FIG. 3, the function menu 222 is displayed in the associated information display area 222 that has appeared at the position of the moved object 212b. Accordingly, the user is able to easily add music pieces to the “Playlist 2” or execute a mail function. In addition, through a representation of moving the object 212 in the shape of a plate such that the object 212 is lifted as shown in the right view of FIG. 3, it is also possible to allow the display content of the object 212 to be viewed even when the associated information is displayed.

The object 212 of the playlist that has been moved in step S110 is still moved while the display object 214 of the object 212 is pressed, so that a state in which the function menu 222 is displayed is maintained. When the finger is lifted off the display object 214, the operation input determination unit 124 determines whether to restore the display position of the object 212 to the initial state shown in the left view of FIG. 3 (S130).

Specifically, the operation input determination unit 124 determines if the pressing time in which the display object 214 is pressed is longer than the first determination time or determines if a predetermined time (referred to as an “end determination time”) has not elapsed from the previous pressing time. If the pressing time is shorter than the first determination time and the end determination time has elapsed from the previous pressing time, it can be determined that the function menu 222 is not used. The end determination time can be set to any given time from the perspective of increasing the operability for the user, and can be set to about five seconds, for example.

Accordingly, while the determination condition for restoring the display position of the object 212 to the initial state is not satisfied in step S130, the process of from step S120 is repeated. Meanwhile, when the determination condition for restoring the display position of the object 212 to the initial state is satisfied in step S130, the display processing unit 126 performs a display process of restoring the object 212 to the initial state (S140). In the process of restoring the object 212 to the initial state, the object 212 may be lowered slowly, for example, in five seconds.

Referring back to the description of step S100, when it is determined that the pressing time is longer than the first determination time in step S100, it is determined if the object 212 is moved while being lifted as shown in the right view of FIG. 3 (S150). If it is determined that the object 212 is already moved in step S150, the process of step S140 is executed so that the object 212 is restored to the initial state. Meanwhile, if it is determined that object 212 is not moved in step S150, the information processing unit 120 does not update the display of the display unit 130, and terminates the process shown in FIG. 2.

The process of calling associated information in accordance with this embodiment has been described. In the process of calling associated information with the information processing unit 120 in accordance with this embodiment, the object 212 of each playlist included in the list of playlists 210 is provided with a movement such as sway that indicates that the object 212 is movable. In addition, each object 212 is provided with the display object 214 that becomes an operation target when the object 212 is moved. When a predetermined operation such as long-press is input to the display object 214 by a user, the display processing unit 126 starts a process of calling associated information. Accordingly, the display object 214 is pressed in and the object 212 is lifted, whereby a display process is performed in which the associated information display area 220 hidden behind appears. As the associated information display area 220 displays functions having high relevance to the information displayed on the object 212, the user is able to easily execute such functions.

Although FIG. 3 illustrates a case where a single object 212 is moved, it is also possible to, while moving a single object (e.g., the object 212b), operate the other objects 212 (e.g., the objects 212a and 212c to 212e).

In the process flow in FIG. 2, as a long-pressing operation is used as a predetermined operation input in step S100, it is determined if the pressing time is longer than a first determination time. Herein, if a short-pressing operation is used as a predetermined operation input, for example, it is determined if the display object 214 has been touched for a time shorter than a predetermined time (a second determination time) in step S100. If the pressing time is shorter than the second determination time, the process of from step S110 is executed. If the pressing time is longer than the second determination time, the process of step S150 is executed.

### (3) Variations

(3-a. Display of Associated Information Display Area)

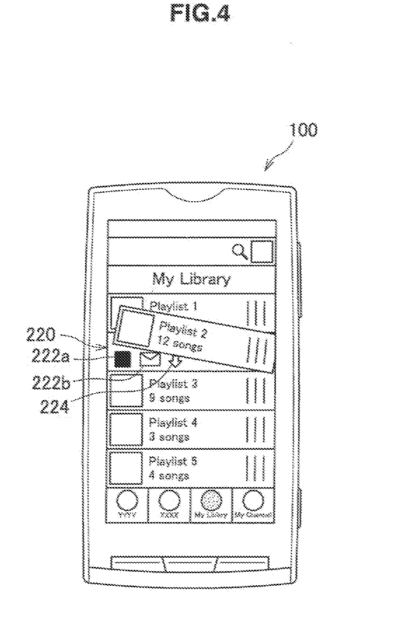

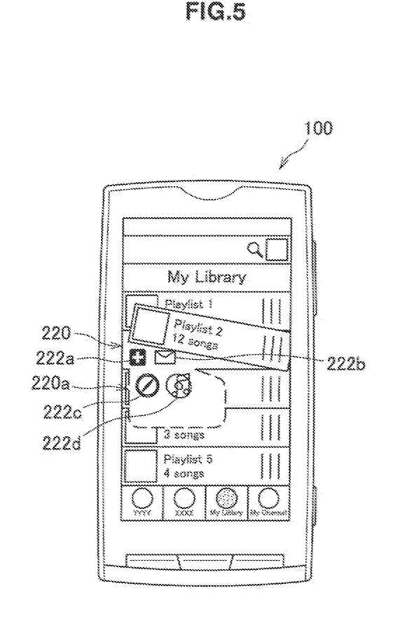

In the example shown in FIG. 3, the function menu 222 associated with the playlist is displayed in the associated information display area 220 that appears after the object 212b has moved. Herein, although the additional icon 222a and the mail icon 222b are displayed as the function menu 222, the function menu 222 may further include other functions. However, there are cases where a sufficient display area is not secured in an area from which the object 212 has moved. As described above, when the entirety of the function menu 222 (associated information) is not able to be displayed in the associated information display area 220, a larger part of the functional menu 222 can be displayed using the display shown in FIG. 4 or 5, for example.

For example, in FIG. 4, when the function menu 222 displayed in the associated information display area 220 includes icons for executing other functions in addition to the additional icon 222a and the mail icon 222b, an additional display object 224 is displayed in the associated information display area 220. The additional display object 224 is an icon for displaying a non-displayed icon of the function menu 222. When a predetermined operation such as tap, for example, is input to the additional display object 224, the display processing unit 126 expands the associated information display area 220, and displays a non-displayed icon of the function menu 222.

The associated information display area 220 can be expanded by displaying an expansion area 220a that expands in a balloon shape from the original associated information display area 220 as shown in FIG. 5, for example. Alternatively, the associated information display area 220 can be expanded by being widened to the display area of the object 212 of the playlist (herein, “Playlist 3”) located below the playlist (herein, “Playlist 2”) of the operation target. Note that the associated information display area 220 may be expanded only when an operation is input to the additional display object 224, or expanded when the associated information display area 200, which appears after the object 212 has moved, is too small to display the function menu 222. Alternatively, instead of or in addition to expanding the associated information display area 220, it is also possible to control the associated information display area to be scrollable.

(3-b. Gradual Movement of Object)

In the example shown in FIG. 3, when a predetermined operation is input to the display object 214, the object 212 is moved so that the associated information display area 220 is displayed. At this time, it is also possible to, by inputting a predetermined operation to the display object 214, further move the object 212 and increase the associated information display area 220.

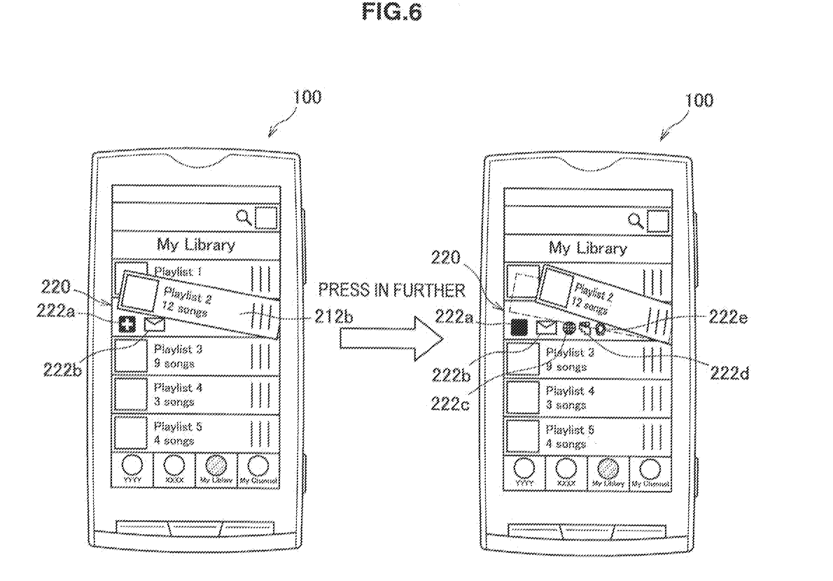

FIG. 6 shows an example in which the object 212 is gradually moved. The state shown in the left view of FIG. 6 is identical to the state shown in the right view of FIG. 3. For example, in the state shown in the left view of FIG. 6, when the display object 214 of the moved object 212b is further pressed in (i.e., pressed for a long time), the display processing unit 126 further increases the amount of movement of the object 212b from the initial state. Accordingly, as shown in the right view of FIG. 6, the object 212b is displayed while being further tilted, and the associated information display area 220 increases.

When the associated information display area 220 increases, the number of icons that can be displayed in the area 220 increases. Thus, as shown in the right view of FIG. 6, icons 222c, 222d, and 222e, which have not been displayed in the state shown in the left view of FIG. 6, come to be displayed. Accordingly, functions that can be executed from the function menu 222 can be increased, and the operability can thus be improved.

In the examples shown in FIG. 3 to FIG. 6, icons of the function menu 222 that are displayed in the associated information display area 220 in the state in which the object 212 is initially moved (e.g., the state shown in the right view of FIG. 3) may be icons with high priorities such as icons that are frequently used. Accordingly, an icon that has a high possibility of being executed by a user can be presented first, and the operability can thus be improved.

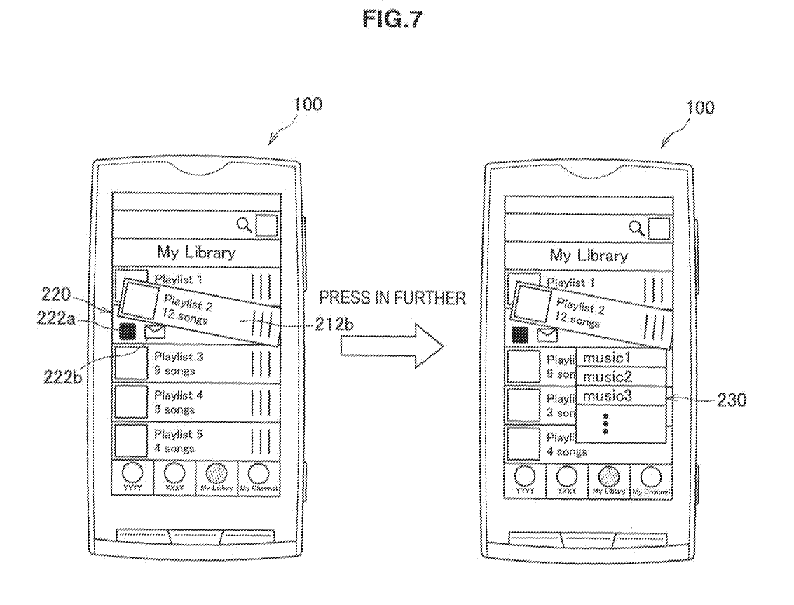

In addition, the display processing unit 126 may, when the display object 214 of the moved object 212b is further pressed in from the state in which the object 212 is initially moved, display the lower-level information of the operation target information. FIG. 7 shows an example in which the lower-level information is displayed. The state shown in the left view of FIG. 7 is identical to the state shown in the right view of FIG. 3. For example, it is assumed that in the state shown in the left view of FIG. 7, the display object 214 of the moved object 212b is further pressed in. Then, the display processing unit 126 displays the lower-level information of the “Playlist 2” that is the operation target, for example, a music playlist 230 indicating the names of music pieces included in the “Playlist 2” at a position below the associated information display area 220. Accordingly, a music piece included in the “Playlist 2” can be selected and a predetermined operation can be performed thereon, so that the operability can be further improved.

(3-c. Display of Associated Information in Accordance with the Movement Direction of Object)

Although the movement direction of the object 212 is a single direction in the example shown in FIG. 3, it is also possible to move the object 212 in a plurality of directions. At this time, associated information displayed in the associated information display area 220 may also be changed in accordance with the movement direction of the object.

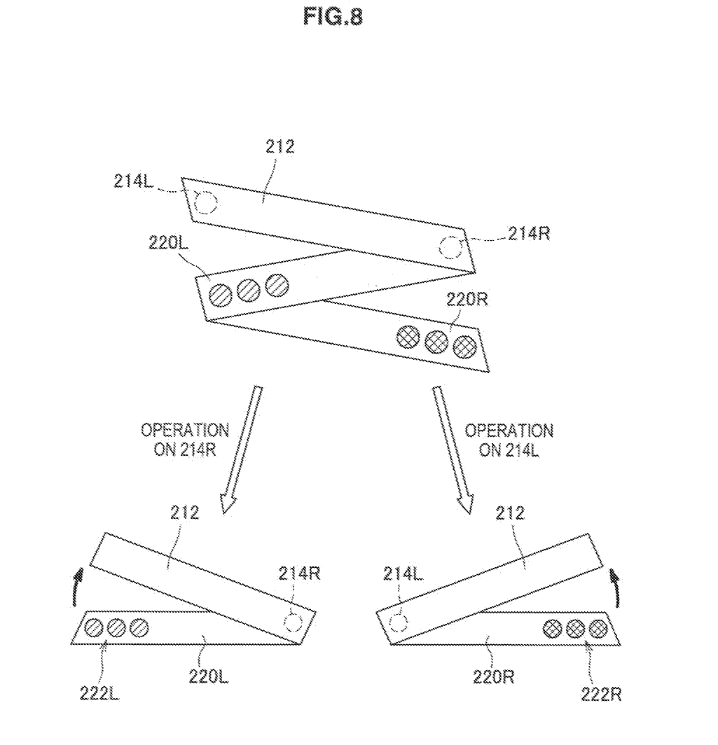

For example, as shown in FIG. 8, an object 212 in the shape of a plate is considered like the one shown in FIG. 3. A first display object 214R is displayed on the right side of the object 212 in the longitudinal direction, and a second display object 214L is displayed on the left side of the object 212 in the longitudinal direction. When a predetermined operation such as long-press is input to the first display object 214R, the display processing unit 126 lifts the object 212 toward a side opposite to the first display object 214R with the first display object 214R serving as the point of effort as shown in the left view of FIG. 8. An associated information display area 220, which has appeared with the movement of the object 212, displays first associated information 222L.

Meanwhile, when a predetermined operation such as long-press is input to the second display object 214L, the display processing unit 126 lifts the object 212 to a side opposite to the second display object 214L with the second display object 214L serving as the point of effort as shown in the lower right view of FIG. 8. Second associated information 222R is displayed in an associated information display area 220R that has appeared with the movement of the object 212. As described above, as the different associated information display areas 220L and 220R are displayed depending on which of the first display object 214R and the second display object 214L is operated, the display object 214R or 214L may be operated in accordance with the associated information to be displayed. In addition, as the associated information display areas 220R and 220L increase, the number of pieces of associated information to be displayed can be increased.

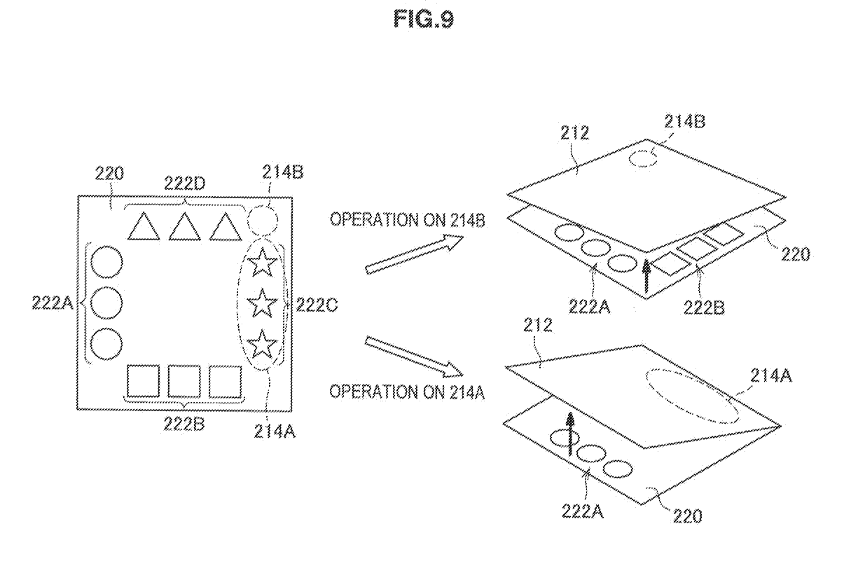

FIG. 9 shows another example in which the object 212 is moved. It is assumed that the object 212 shown in FIG. 9 is square in shape, and a square associated information display area 220 is stacked below the object 212. It is also assumed that as shown in the left view of FIG. 9, associated information 222A, 222B, 222C, and 222D are displayed in the associated information display area 220 along the four sides thereof.

Hereinafter, description will be made of a case where a predetermined operation is input to each of the display object 214A provided on one side of the object 212 and the display object 214B provided at the corner of the object 212. First, when a predetermined operation such as long-press is input to the display object 214A, the display processing unit 126 lifts the object 212 to a side opposite to the display object 214A with the display object 214A serving as the point of effort as shown in the upper right view of FIG. 9. The associated information display area 220, which has appeared with the movement of the object 212, displays associated information 222A located on a side opposite to the display object 214A.

Meanwhile, when a predetermined operation such as long-press is input to the display object 214B, the display processing unit 126 lifts the object 212 from a corner that is opposite the display object 214B with the display object 214B serving as the point of effort as shown in the lower right view of FIG. 9. Associated information 222A and 222B are displayed in an associated information display area 220 that has appeared with the movement of the objet 212. In this manner, different associated information 222A to 222D can be displayed depending on which of the display objects 214A and 214B displayed at different positions are operated, and the number of pieces of associated information that can be displayed can be increased.

Note that the shape of the object 212 may be, other than a plate and a rectangle shown in FIGS. 8 and 9, other polygons, circle, ellipse, or cube.

### 2. Second Embodiment

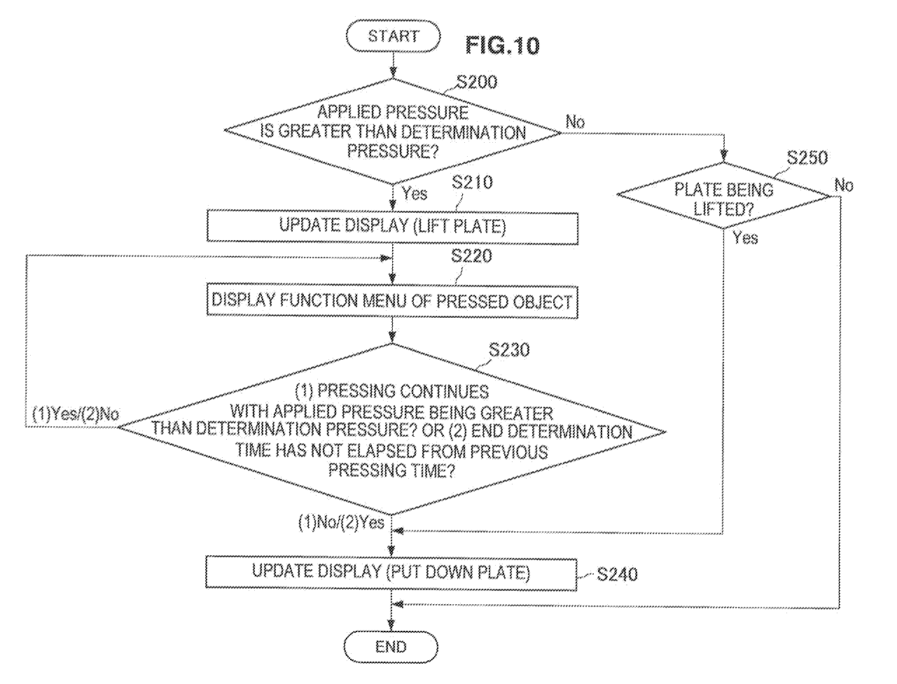

Next, a process of calling associated information with the information processing unit 120, which is an information processing device in accordance with the second embodiment of the present disclosure, will be described with reference to FIG. 10. The information processing unit 120 in accordance with this embodiment differs from that in the first embodiment in that if the object 212 is movable is determined on the basis of, instead of the pressing time in which the target object is pressed by an input object, pressure applied to the target object. Hereinafter, processes that differ from those in the first embodiment will be described in detail, and identical processes will be described briefly.

### [2-1. Functional Configuration of Mobile Terminal]

The functional configuration of the mobile terminal 100 having the information processing unit 120 in accordance with this embodiment is substantially identical to the configuration of the mobile terminal 100 in accordance with the first embodiment shown in FIG. 1, but differs in that the operation input detection unit 110 detects pressure applied to the display surface using a pressure-sensitive touch panel, and outputs the detection ID, positional information, contact time, and pressure as a detection signal to the information processing unit 120. The information processing unit 120 performs a process of calling associated information on the basis of the detection signal including the magnitude of the pressure. The other configurations are the same as those in the first embodiment. Thus, description of the other configurations is omitted herein.

### [2-2. Process of Calling Associated Information]

Next, a process of calling associated information with the information processing unit 120 in accordance with this embodiment will be described with reference to FIGS. 10 and 3. Note that FIG. 10 is a flowchart showing a process of calling associated information with the information processing unit 120 in accordance with this embodiment. Hereinafter, a process of calling associated information in accordance with this embodiment will be described with reference to the explanatory views in FIG. 3 used in the first embodiment.

The operation input detection unit 110 of the mobile terminal 100 in accordance with this embodiment continuously monitors contact of an input object on the display unit 130. Then, upon detecting a touch of the input object on the display unit 130, the operation input detection unit 110 outputs a detection signal to the information processing unit 120.

The information processing unit 120, upon receiving the detection signal, determines if the touch position of the input object is the display object 214 displayed on the object 212 of the playlist with the position determination unit 122. If the input object does not touch the display object 214, a process of calling an associated function is not executed. Meanwhile, if the input object touches the display object 214, the operation input determination unit 124 determines if a predetermined operation is input to the display object 214 for starting execution of a process of calling an associated function (S200).

In this embodiment, press-in of the display object 214 is used as a requirement to determine that a predetermined operation is input. Specifically, the operation input determination unit 124 determines if pressure applied to the display object 214 is greater than the determination pressure, and if the applied pressure is determined to be greater than the determination pressure, starts a process of calling associated information. First, with the display processing unit 126, the object 212 on which the selected display object 214 is displayed is moved, so that the associated information display area 220 is displayed (S210).

For example, in the example shown in FIG. 3, the display object 214b of the selected “Playlist 2” is pressed in. When the operation input determination unit 124 determines that the display object 214b is pressed in, the display processing unit 126 moves the object 212b of the “Playlist 2” so that the object 212b is lifted to the side of the user as shown in the right view of FIG. 3. Then, the display processing unit 126 displays the function menu 222 in the associated information display area 220 displayed at a position where the moved object 212 has been located (S220).

The object 212 of the playlist that has been moved in step S210 is still moved while the display object 214 of the object 212 is pressed, so that a state in which the function menu 222 is displayed is maintained. When a finger is lifted off the display object 214, the operation input determination unit 124 determines whether to restore the display position of the object 212 to the initial state shown in the left view of FIG. 3 (S230).

Specifically, the operation input determination unit 124 determines if the pressure applied to the display object 214 is greater than the determination pressure or determines if the end determination time has not elapsed from the previous pressing time. If the applied pressure is less than the determination pressure and the predetermined time has elapsed from the previous pressing time, it can be determined that the function menu 222 is not used. Accordingly, when a determination condition for restoring the display object of the object 212 to the initial state is not satisfied in step S230, the process of from step S220 is repeated. Meanwhile, when a determination condition for restoring the display position of the object 212 to the initial state is satisfied in step S230, the display processing unit 126 performs a display process of restoring the object 212 to the initial state (S240).

Back to the description of step S200, if the applied pressure is determined to be greater than the determination pressure in step S200, it is determined if the object 212 is moved while being lifted as shown in the right view of FIG. 3 (S250). If it is determined that the object 212 is already moved in step S250, the process of step S240 is executed, and the object 212 is restored to the initial state. Meanwhile, if it is determined that the object 212 is not moved in step S250, the information processing unit 120 terminates the process shown in FIG. 10 without updating the display of the display unit 130.

The process of calling associated information in accordance with this embodiment has been described. In the process of calling associated information with the information processing unit 120 in accordance with this embodiment, the object 212 of each playlist included in the list of playlists 210 is provided with a movement such as sway that indicates that the object 212 is movable. In addition, each object 212 is provided with the display object 214 that becomes an operation target when the object 212 is moved. When a predetermined operation such as press-in is input to the display object 214 by a user, the display processing unit 126 starts a process of calling associated information. Accordingly, the display object 214 is pressed in and the object 212 is lifted, whereby a display process is performed in which the associated information display area 220 hidden behind appears. As the associated information display area 220 displays functions having high relevance to the information displayed on the object 212, the user is able to easily execute such functions.

### 3. Exemplary Hardware Configuration

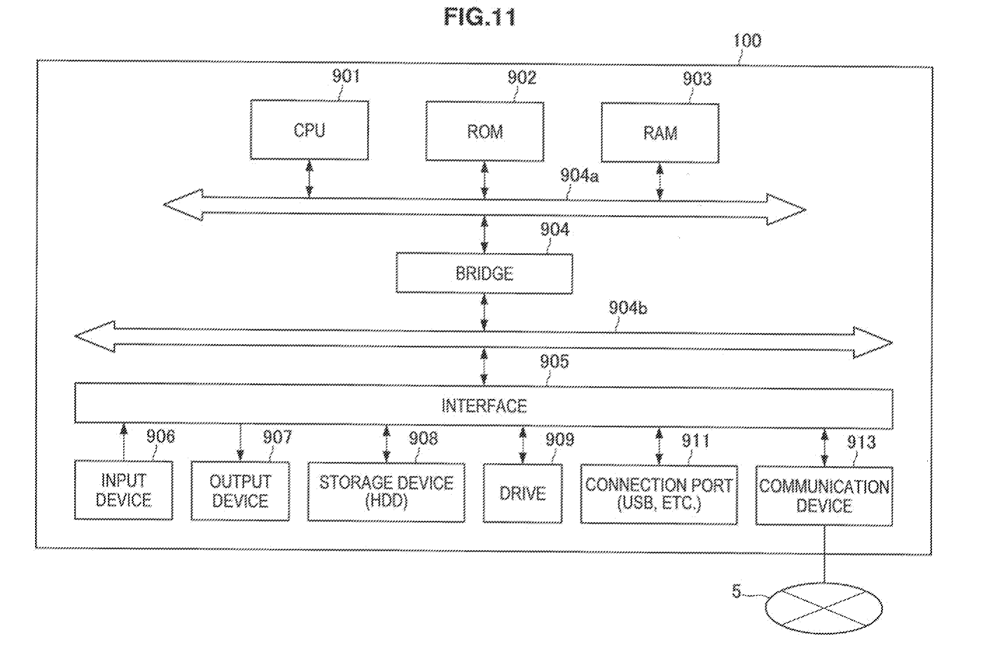

A process of the mobile terminal 100 having the information processing unit 120 in accordance with this embodiment can be executed either by hardware or software. In such a case, the mobile terminal 100 can be configured as shown in FIG. 11. Hereinafter an exemplary hardware configuration of the mobile terminal 100 in accordance with this embodiment will be described with reference to FIG. 11.

The mobile terminal 100 in accordance with this embodiment can be realized by a processing device such as a computer as described above. The mobile terminal 100 includes, as shown in FIG. 11, a CPU (Central Processing Unit) 901, ROM (Read Only Memory) 902, RAM (Random Access Memory) 903, and a host bus 904a. The mobile terminal 100 also includes a bridge 904, an external bus 904b, an interface 905, an input device 906, an output device 907, a storage device (HDD) 908, a drive 909, a connection port 911, and a communication device 913.

The CPU 901 functions as an arithmetic processing unit and a control unit, and controls the overall operation within the mobile terminal 100 in accordance with various programs. The CPU 901 may also be a microprocessor. The ROM 902 stores programs, operation parameters, and the like that are used by the CPU 901. The RAM 903 temporarily stores programs used in execution of the CPU 901, parameters that change as appropriate during the execution of the CPU 901, and the like. These components are mutually connected by the host bus 904a including a CPU bus or the like.

The host bus 904a is connected to the external bus 904b such as a PCI (Peripheral Component Interconnect/Interface) bus via the bridge 904. Note that the host bus 904a, the bridge 904, and the external bus 904b need not be provided separately, and the functions of such components may be integrated into a single bus.

The input device 906 includes input means for a user to input information, such as a mouse, keyboard, touch panel, button, microphone, switch, and lever; an input control circuit that generates an input signal in response to a user's input and outputs the signal to the CPU 901, and the like. Examples of the output device 907 include a display device such as a liquid crystal display (LCD) device, an OLED (Organic Light Emitting Diode) device, or a lamp; and an audio output device such as a speaker.

The storage device 908 is an exemplary storage unit of the mobile terminal 100. This is a device for storing data. The storage device 908 may include a memory medium, a recording device for recording data on the memory medium, a reading device for reading data from the memory medium, an erasing device for erasing data recorded on the memory medium, and the like. The storage device 908 is, for example, an HDD (Hard Disk Drive). The storage device 908 stores programs and various data that drive the hard disk and are executed by the CPU 901.

The drive 909 is a reader/writer for a memory medium, and is incorporated in or externally attached to the mobile terminal 100. The drive 909 reads information recorded on a mounted removable recording medium such as a magnetic disk, an optical disc, a magneto-optical disk, or semiconductor memory, and outputs the information to the RAM 903.

The connection port 911 is an interface to be connected to an external device. This is a connection port to an external device that can transfer data via a USB (Universal Serial Bus), for example. The communication device 913 is a communication interface including a communication device or the like to be connected to a communications network 5. The communication device 913 may be any of a communication device supporting a wireless LAN (Local Area Network), a communication device supporting a wireless USB, and a wired communication device that performs wired communication.

Although the preferred embodiments of the present disclosure have been described in detail with reference to the appended drawings, the present disclosure is not limited thereto. It is obvious to those skilled in the art that various modifications or variations are possible insofar as they are within the technical scope of the appended claims or the equivalents thereof. It should be understood that such modifications or variations are also within the technical scope of the present disclosure.

It should be understood by those skilled in the art that various modifications, combinations, sub-combinations and alterations may occur depending on design requirements and other factors insofar as they are within the scope of the appended claims or the equivalents thereof.

For example, although the aforementioned embodiments illustrate examples in which the information processing unit 120 is provided in the mobile terminal 100, the present technology is not limited thereto. For example, the function of the information processing unit 120 may be provided in a server that is connected to the mobile terminal 100 via a network in a communicable manner. At this time, the mobile terminal 100 can implement the aforementioned process by transmitting a detection result obtained by the operation input detection unit 110 to a server via a communication unit (not shown), performing a process with an information processing unit provided in the server, and transmitting the processing result to the mobile terminal 100.

In addition, although the aforementioned embodiments illustrate examples in which after the object 212 of the playlist represented in the shape of a plate is moved, the moved object 212 is restored to the initial state upon input of a predetermined operation, the present technology is not limited thereto. For example, a process of restoring the moved object 212 to the initial state may be started when the list of playlists 210 is scrolled or when a back key of the mobile terminal 100 is pressed, for example. Alternatively, the moved object 212 may be restored to the initial state by directly moving the object 212 with a finger back to the original position.

Further, although the aforementioned embodiments illustrate examples in which a process of calling associated information with the information processing unit 120 is applied to a music application, the present technology is not limited thereto. The aforementioned process can also be applied to an application that displays lists such as, for example, an e-mail list of e-mail software, a phone number list and posting/browse services of phone book software, or an RSS reader.

Additionally, the present technology may also be configured as below.

(1) An information processing device, comprising:

a position determination unit configured to, on the basis of a touch position of an input object on a display unit that displays first information, determine a touch on a display object that displays second information associated with the first information;

an operation input determination unit configured to determine if a predetermined operation is input to the display object; and

a display processing unit configured to, on the basis of determination results obtained by the position determination unit and the operation input determination unit, move a display position of the first information so that the second information is displayed at a position in which the moved first information has been displayed.

(2) The information processing device according to (1), wherein the operation input determination unit determines if a long-pressing operation in which the input object touches the display object for a time longer than or equal to a first determination time is performed.
(3) The information processing device according to claim (1), wherein the operation input determination unit determines if a short-pressing operation in which the input object touches the display object for a time shorter than a second determination time is performed.
(4) The information processing device according to (1), wherein the operation input determination unit determines if the input object has applied pressure that is greater than or equal to determination pressure to the display object.
(5) The information processing device according to any one of (1) to (4), wherein

the display object is provided at an end portion of a first display area in which the first information is displayed, and

when the input object touches the display object and a predetermined operation is input to the display object, the display processing unit displays the first display area so that the first display area is lifted toward a user who is opposite the display unit with the display object serving as the point of effort, and displays a second display area in which the second information is displayed below the moved first display area.

(6) The information processing device according to (5), wherein when an entirety of the second information is not displayed in the second display area displayed on the display unit by a movement of the first display area, the display processing unit displays an additional display object indicating that there remains part of the second information that is not displayed in the second display area, and displays, when the additional display object is selected, at least a part of the second display information that has not been displayed on the display unit.
(7) The information processing device according to (5) or (6), wherein when an entirety of the second information is not displayed on the second display area displayed on the display unit by a movement of the first display area, the display processing unit displays at least a part of the second information that has not been displayed by expanding the second display area.
(8) The information processing device according to any one of (5) to (7), wherein when the input object touches the display object and a predetermined operation is input to the display object again after the second information is displayed on the basis of the determination results obtained by the position determination unit and the operation input determination unit, the display processing unit increases a movement amount of the first display area so that the second display area is enlarged.
(9) The information processing device according to any one of (5) to (7), wherein when the input object touches the display object and a predetermined operation is input to the display object again after the second information is displayed on the basis of the determination results obtained by the position determination unit and the operation input determination unit, the display processing unit further displays lower-level information associated with the second information.
(10) The information processing device according to any one of (1) to (9), wherein the display processing unit, after displaying the second information on the basis of the determination results obtained by the position determination unit and the operation input determination unit, displays the first information at a position after the movement until the input object is moved away from the display object.
(11) The information processing device according to any one of (1) to (10), wherein the display processing unit changes the second information displayed in the second display area in accordance with a movement direction of the first display area.
(12) The information processing device according to any one of (1) to (11), wherein the display processing unit provides the first information displayed on the display unit with a movement indicating that the first information is movable.

The present disclosure contains subject matter related to that disclosed in Japanese Priority Patent Application JP 2011-244344 filed in the Japan Patent Office on Nov. 8, 2011, the entire content of which is hereby incorporated by reference.

What is claimed is:

1. An information processing device, comprising:
a position determination unit configured to, on the basis of a touch position of an input object on a display unit that displays first information, determine a touch on a display object that displays second information associated with the first information;
an operation input determination unit configured to determine if a predetermined operation is input to the display object; and
a display processing unit configured to, on the basis of determination results obtained by the position determination unit and the operation input determination unit, move a display position of the first information so that the second information is displayed at a position in which the moved first information has been displayed.

2. The information processing device according to claim 1, wherein the operation input determination unit determines if a long-pressing operation in which the input object touches the display object for a time longer than or equal to a first determination time is performed.

3. The information processing device according to claim 1, wherein the operation input determination unit determines if a short-pressing operation in which the input object touches the display object for a time shorter than a second determination time is performed.

4. The information processing device according to claim 1, wherein the operation input determination unit determines if the input object has applied pressure that is greater than or equal to determination pressure to the display object.

5. The information processing device according to claim 1, wherein
the display object is provided at an end portion of a first display area in which the first information is displayed, and
when the input object touches the display object and a predetermined operation is input to the display object, the display processing unit displays the first display area so that the first display area is lifted toward a user who is opposite the display unit with the display object serving as the point of effort, and displays a second display area in which the second information is displayed below the moved first display area.

6. The information processing device according to claim 5, wherein when an entirety of the second information is not displayed in the second display area displayed on the display unit by a movement of the first display area, the display processing unit displays an additional display object indicating that there remains part of the second information that is not displayed in the second display area, and displays, when the additional display object is selected, at least a part of the second display information that has not been displayed on the display unit.

7. The information processing device according to claim 5, wherein when an entirety of the second information is not displayed on the second display area displayed on the display unit by a movement of the first display area, the display processing unit displays at least a part of the second information that has not been displayed by expanding the second display area.

8. The information processing device according to claim 5, wherein when the input object touches the display object and a predetermined operation is input to the display object again after the second information is displayed on the basis of the determination results obtained by the position determination unit and the operation input determination unit, the display processing unit increases a movement amount of the first display area so that the second display area is enlarged.

9. The information processing device according to claim 5, wherein when the input object touches the display object and a predetermined operation is input to the display object again after the second information is displayed on the basis of the determination results obtained by the position determination unit and the operation input determination unit, the display processing unit further displays lower-level information associated with the second information.

10. The information processing device according to claim 1, wherein the display processing unit, after displaying the second information on the basis of the determination results obtained by the position determination unit and the operation input determination unit, displays the first information at a position after the movement until the input object is moved away from the display object.

11. The information processing device according to claim 1, wherein the display processing unit changes the second information displayed in the second display area in accordance with a movement direction of the first display area.

12. The information processing device according to claim 1, wherein the display processing unit provides the first information displayed on the display unit with a movement indicating that the first information is movable.

13. An information processing method, comprising:
determining, on the basis of a touch position of an input object on a display unit that displays first information, a touch on a display object that displays second information associated with the first information;
determining if a predetermined operation is input to the display object; and
moving, on the basis of determination results obtained by the position determination unit and the operation input determination unit, a display position of the first information so that the second information is displayed at a position in which the moved first information has been displayed.

14. A computer program causing a computer to function as an information processing device, the information processing device including:
a position determination unit configured to, on the basis of a touch position of an input object on a display unit that displays first information, determine a touch on a display object that displays second information associated with the first information;
an operation input determination unit configured to determine if a predetermined operation is input to the display object; and
a display processing unit configured to, on the basis of determination results obtained by the position determination unit and the operation input determination unit, move a display position of the first information so that the second information is displayed at a position in which the moved first information has been displayed.
